(19) United States
(12) Patent Application Publication
(10) Pub. No.: US 2011/0141271 A1
(43) Pub. Date: Jun. 16, 2011

(54) REARVIEW CAPTURE SYSTEM AND CAR USING SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/710,371

(22) Filed: Feb. 23, 2010

(30) Foreign Application Priority Data
Dec. 14, 2009 (CN) 200910311387.1

(51) Int. Cl. H04N 7/18; H02J 7/35; F03D 9/00

(52) U.S. Cl. 348/135; 320/101; 290/55; 348/E07.085

(57) ABSTRACT

A rearview capture system adapted to be used for a car includes a camera unit, a display unit, a processor, an energy conversion device, and a rechargeable battery. The camera unit is set in the car, and configured for capturing images of the rear view of the car. The display unit is provided in a compartment of the car. The processor is electrically connected to the camera unit and the display unit, and configured for controlling the display unit to display the images captured by the camera unit. The energy conversion device is configured for converting one or more types of natural energy into electrical energy. The rechargeable battery is capable of being charged by the energy conversion device, and configured for powering the rearview capture system.

### BACKGROUND

1. Technical Field

The present disclosure relates to cars and particularly, to a car with a rearview capture system.

2. Description of Related Art

For safety consideration, some cars are equipped with a rearview capture system. The rearview capture system includes a camera disposed on the car with a view of the rear of the car, and a display. The rearview capture system gives the driver a rearview on the display. However, the rearview capture system normally requires external power source such as the car's battery and may drain the car's battery.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of a car with a rearview capture system. Moreover, in the drawings, like reference numerals designate corresponding parts throughout several views.

FIG. 1 is a schematic view of a car with a rearview capture system, according to an exemplary embodiment.

FIG. 2 is a functional block diagram of the rearview capture system of FIG. 1, including a solar panel, a wind energy conversion unit, and a rechargeable battery.

FIG. 3 is a structural schematic view of the solar panel and the rechargeable battery of the rearview capture system of FIG. 1.

FIG. 4 is a structural schematic view of the wind energy conversion unit of the rearview capture system of FIG. 1.

### DETAILED DESCRIPTION

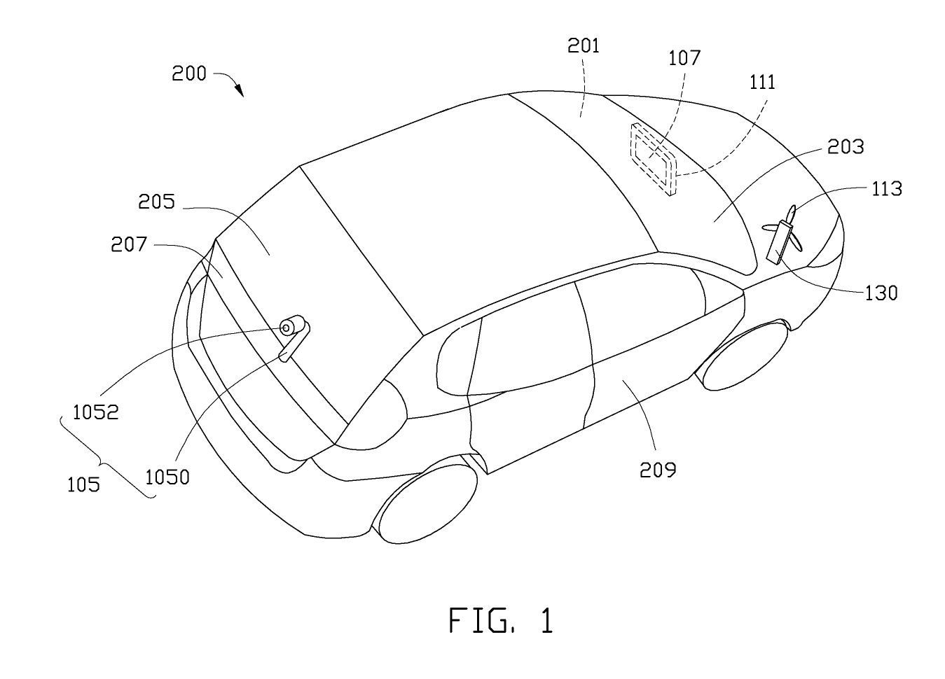

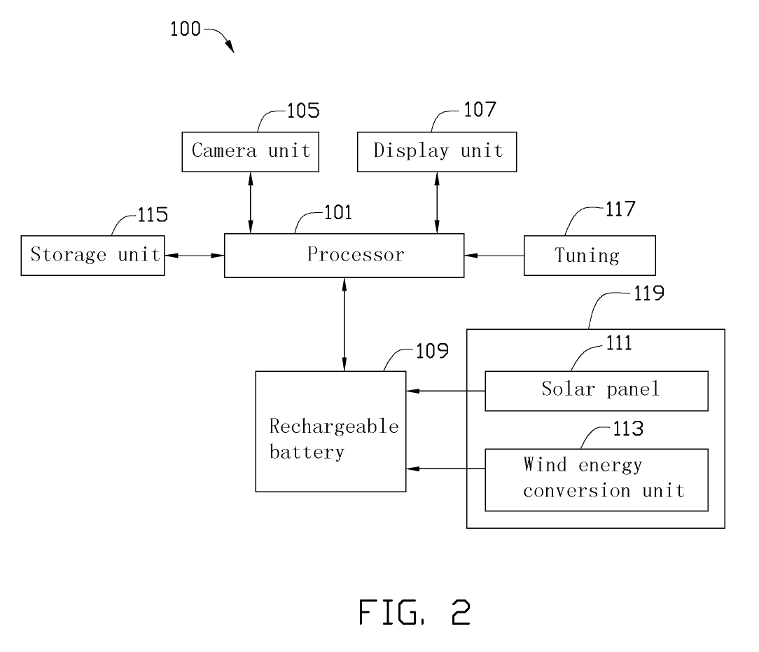

Referring to FIGS. 1 and 2, a rearview capture system 100 used for a car 200 in accordance with one embodiment is illustrated. The car 200 includes a passenger compartment 201, a windshield 203, a rear window 205, a rear portion 207, and a body 209. The compartment 201 is defined by the body 209. The windshield 203 is set at the front of the compartment 201. The rear window 205 is set at the rear portion 207. The rear portion 207 is connected to the body 209.

The rearview capture system 100 includes a processor 101, a camera unit 105, a display unit 107, a rechargeable battery 109, an energy conversion device 119, a storage unit 115, and a tuning 117.

The camera unit 105 is configured to capture rearward looking images from the rear portion 207. The camera unit 105 includes a base 1050 and a camera 1052 mounted on the base 1050. The camera 1052 may be a water-proof and wide-angle camera. The base 1050 is set in the rear portion 207 to hold the camera 1052. In other embodiments, the base 1050 can be set in the body 209, therefore, the camera 1052 captures images through the rear window 205. In other embodiments, in order to protect the camera 1052, the camera unit 105 may include a waterproof case (not shown) for receiving the camera 1052.

The tuning unit 117 is configured for receiving television (TV) and radio signals. In this embodiment, the tuning 117 includes a TV tuner for receiving the TV signals and a frequency/amplitude modulation (FM/AM) tuner for receiving radio signals.

The display unit 107 is configured for displaying the images captured by the camera unit 105, and outputting the received TV signals and the radio signals received by the tuning 117. The display unit 107 may be, for example, a cathode ray tube (CRT) display or a liquid crystal display. The display unit 107 is set to be viewed by a driver in the compartment 201. The storage unit 115 is configured for storing the images captured by the camera unit 105.

The energy conversion device 119 is configured for converting one or more types of natural energy into electrical energy and storing the electrical energy in the rechargeable battery 109. The energy conversion device 119 includes a solar panel 111 and a wind energy conversion unit 113.

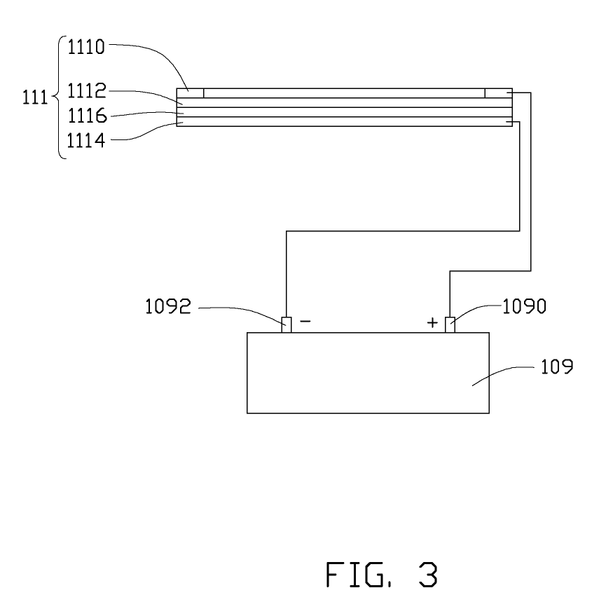

The solar panel 111 is set somewhere in or on the car 200 where it can best receive sunlight. In this embodiment the panel 111 is set on the back of the display unit 107 to receive sunlight penetrating through the windshield 203. Referring to FIG. 3, in this embodiment, the solar panel 111 includes a front electrode 1110, a transparent conductive layer 1112, a back electrode 1114, and a photovoltaic semiconductor layer 1116 arranged between the transparent conductive layer 1112 and the back electrode 1114. Sunlight penetrates to the transparent conductive layer 1112 through the front electrode 1110. When the transparent conductive layer 1112 receives the sunlight, the photovoltaic semiconductor layer 1116 forms a voltage between the front electrode 1110 and the back electrode 1114, and realizes photo-electron conversion. In other embodiment, the solar panel 111 can be other structures.

The rechargeable battery 109 is provided on the body 209, and configured for powering the rearview capture system 100. The rechargeable battery 109 includes a positive electrode 1090 and a negative electrode 1092. When the front electrode 1110 is electrically connected to the positive electrode 1090, and the back electrode 1114 is electrically connected to the negative electrode 1092, the rechargeable battery 109 is charged by the solar panel 111. In this embodiment, the front electrode 1110 and the back electrode 1114 are electrically connected to the positive electrode 1090 and the negative electrode 1092 respectively through conductive wires, and those wires are hidden inside the body 209.

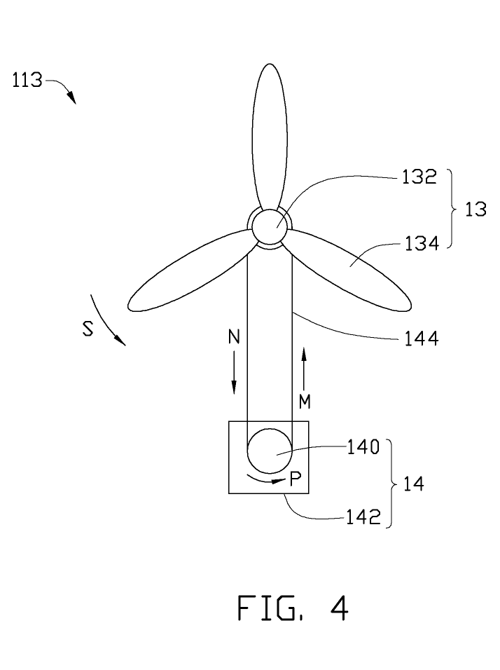

Further referring to FIG. 4, the wind energy conversion unit 113 is configured for converting wind energy into electrical energy and storing the electrical energy in the rechargeable battery 109. The wind energy conversion unit 113 includes a turbine 13 and a generator 14.

The turbine 13 includes a support member 130, a rotating shaft 132, and a plurality of blades 134. The plurality of blades 134 is provided on the rotating shaft 132, in this embodiment, the number of the blades 134 is three. The rotating shaft 132 is connected to the support member 130 (see FIG. 1). The support member 130 is fixed on the body 209 for the plurality of blades 134 to be turned by wind energy outside the body 209. In this embodiment, the support member 130 is fixed in front of the windshield 203 to receive wind energy easily. In other embodiments, the support member 130 can be fixed on the top of the body 209.

The generator 14 is provided on the body 209 and configured for generating electrical energy. The generator 14 includes a rotor 140, a stator 140, and a driving belt 144. The rotor 140 is connected to the rotating shaft 132 by the driving belt 144. The driving belt 144 is provided inside the support member 130. The plurality of blades 134 rotates the rotating shaft 132 in a direction indicated by an arrow S, and the driving belt 144 rotates along a direction indicated by two arrows M and N. The rotor 140 of the generator 14 rotates in a direction indicated by an arrow P, and drives the stator 140 to output voltage. The negative and positive voltage outputs of the generator 13 are connected to the anode 1090 and the cathode 1092 of the rechargeable battery 109 respectively to form a circuit (not shown) that can charge the rechargeable battery 109. In this embodiment, the generator 14 further includes an input shaft (not shown) coupled to the rotating shaft 123.

The processor 101 is for controlling the camera 1052 to capture images. The processor 101 is further configured for receiving the images captured by the camera 1052, and sending the captured images to the display unit 107 to display. The processor 101 is also configured for receiving the TV signals and the radio signals received by the tuning 117, and sending the received TV signals and radio signals to a display and a loudspeaker of the display unit 107 as outputs. The processor 101 is further configured for controlling the rechargeable battery 109 to power the rearview capture system 100. The processor 101 is also configured for storing images captured by the camera 1052 into the storage unit 115.

The rearview capture system 100 convert solar energy and wind energy into electrical energy to provide power through the solar panel 111 and the wind energy conversion unit 113. The car 200 using the rearview capture system 100 implements recycle of green energy, and conforms to current concerns over environmental friendliness.

It is to be understood, however, that even though numerous has been described with reference to particular embodiments, but the present disclosure is not limited to the particular embodiments described and exemplified, and the embodiments are capable of considerable variation and modification without departure from the scope of the appended claims.

What is claimed is:

1. A rearview capture system adapted to be used with a car, the rearview capture system comprising:
a camera unit set in the car, the camera unit configured for capturing images of the rear view of the car;
a display unit provided in a compartment of the car;
a processor electrically connected to the camera unit and the display unit, the processor configured for controlling the display unit to display the images captured by the camera unit;
an energy conversion device configured for converting one or more types of natural energy into electrical energy; and
a rechargeable battery capable of being charged by the energy conversion device, the rechargeable battery configured for powering the rearview capture system.

2. The rearview capture system of claim 1, wherein the energy conversion device comprises a solar panel set on the back of the display unit to receive sunlight penetrating through a windshield of the car, the solar panel is configured for converting solar energy into electrical energy, and charging the rechargeable battery.

3. The rearview capture system of claim 2, wherein the rechargeable battery has a positive electrode and a negative electrode, and the solar panel has a front electrode and a back electrode, the positive electrode of the rechargeable battery is connected to the front electrode of the solar panel, and the negative electrode of the rechargeable battery is connected to the back electrode of the solar panel.

4. The rearview capture system of claim 1, wherein the energy conversion device further comprises a wind energy conversion unit configured for converting wind energy into electrical energy and charging the rechargeable battery.

5. The rearview capture system of claim 4, wherein the wind energy conversion unit comprises:
a turbine comprising:
a support member fixed on a body of the car;
a rotating shaft rotatably mounted on the support member; and
a plurality of blades fixed on the rotating shaft; and
a generator provided on the body of the car, the generator comprising an input shaft coupled to the rotating shaft.

6. The rearview capture system of claim 5, wherein the generator comprises a rotor, a stator, and a driving belt, the rotor is connected to the rotating shaft by the driving belt, the driving belt is provided inside the body.

7. The rearview capture system of claim 1, wherein the camera unit comprises a base and a camera mounted on the base, the base is set in a rear portion of the car to hold the camera.

8. The rearview capture system of claim 1, wherein the camera unit comprises a base and a camera mounted on the base, the base is internally set in a body of the car to hold the camera for capturing images through a rear window of the car.

9. The rearview capture system of claim 1, further comprising a storage unit configured for storing the images captured by the camera unit.

10. The rearview capture system of claim 1, further comprising a tuning configured for receiving television signals and radio signals, the tuning comprising a television tuner for receiving the television signals and a frequency/amplitude modulation tuner for receiving the radio signals.

11. A car installed with a rearview capture system, the car comprising:
a rear portion for setting a camera unit of the rearview capture system to capture images of the rear view of the car;
a compartment for receiving a processor and a display unit of the rearview capture system, the processor configured for controlling the display unit to display the images captured by the camera unit; and
a body defining the compartment configured for setting an energy conversion device and a rechargeable battery of the rearview capture system, the energy conversion device configured for converting one or more types of natural energy into electrical energy, the rechargeable battery capable of being charged by the energy conversion device and configured for powering the rearview capture system.

12. The car of claim 11, further comprising a front windshield, a solar panel of the energy conversion device set on the back of the display unit to receive sunlight penetrating through the windshield.

13. The car of claim 11, further comprising a rear window set in the rear portion, the camera capturing images through the rear window.

14. The car of claim 11, wherein the body is further configured for fixing a wind energy conversion unit of the energy conversion device on the outside of the car to receive wind energy.
